(19) United States
(12) Patent Application Publication
(10) Pub. No.: US 2004/0059905 A1
(43) Pub. Date: Mar. 25, 2004

(54) Method and apparatus for short-power cycle detection

(76) Inventor: George R. Soulier, Weiser, ID (US)

Correspondence Address: HEWLETT-PACKARD COMPANY, Intellectual Property Administration, P.O. Box 272400, Fort Collins, CO, 80527-2400, US

(21) Appl. No.: 10/247,033

(22) Filed: Sep. 19, 2002

(51) Int. Cl. G06F 9/00

(52) U.S. Cl. 713/2

(57) ABSTRACT

A circuit in an electronic device, such a computer, printer, copier and the like, evaluates a duration of a power cycle of the electronic device. The circuit, upon detection of a sufficiently brief power cycle, selects a shortened boot-up sequence to expedite recovery of the electronic device into an operational state. The circuit includes a short-power cycle detector which retains a power cycle status for use in evaluation of the power cycle duration and a charging circuit for updating the power cycle status. Timing elements for providing isolation of the charging circuit during evaluation and the updating of the power cycle status during an operational state are also presented.

### BACKGROUND OF THE INVENTION

1. Field of the Invention

The present invention relates generally to electronic device power management and, more specifically, relates to detection of power cycling of electronic equipment.

2. State of the Art

Electronic devices, such as computers and other processing based instruments including printers, copiers and the like, have become commonplace in modern society. As user expectations increase, the complexities associated with such devices also increase. Because of the complex nature of electronic devices, there are many processes that occur internally that require a significant amount of setup time and testing within these devices prior to becoming fully operational for their intended purposes. For example, many complex electronic devices include startup routines that include self-tests, calibration and initialization of processing components. The time associated with this “boot-up” is annoying and tedious and is a common source of user complaint. Furthermore, the financial impact to an organization imposed by users being unproductive during this boot-up process is staggering.

Most users of such electronic devices have become accustomed to such a time-consuming boot-up condition but remain intolerant to undergoing frequent boot-up processes. In addition to the enhanced startup times resulting from the complexity of electronic devices, such device complexity also results in operational errors within the electronic devices that cannot be detected and internally remedied by the device itself. Many electronic devices, therefore, require a manual intervention to “power cycle” the device, thereby allowing the processing electronics to reinitiate operations from a known starting point.

Such power cycling of an electronic device has heretofore resulted in the re-execution of the entire boot-up sequence even for those portions of the boot sequence that do not necessarily need to be re-executed. For example, if a power cycle is of a lengthy duration, many of the processes or subsystems require execution in order to ready that subsystem for performance within the electronic device. However, if the power cycle is of such a short duration that some of the subsystems retain their readiness, then the re-execution of the testing and preparation portions of the subsystems results in an unnecessarily elongated boot-up sequence. Therefore, there exists a need to determine the length of a power cycle in order to better enhance and streamline a boot-up sequence within an electronic device.

### BRIEF SUMMARY OF THE INVENTION

The present invention provides devices, circuits and methods for evaluating a power cycle of an electronic device and determining if the power cycle is of sufficiently short duration to enable a shortened boot sequence. The invention finds application in electronic devices including, but not limited to, computers, printers, copiers, and the like where the boot-up sequence is of sufficient duration as to be desirably shortened when possible.

The device and method includes a short-power cycle detector which comprises a power cycle status that indicates a duration of a current power cycle following a completed boot sequence. The power cycle status is stored in a temporarily nonvolatile manner such that, upon power recovery, the processing logic evaluates the status to determine if the power outage has been sufficiently brief such that certain portions of the processes within the electronic device retain their operational integrity and the initialization and verification associated with those processes may be omitted to expedite the rebooting of the electronic device.

The device and method further include circuits and operational steps to provide timing and delay associated with the isolation and retention of the status during the reapplication of power to the electronic device. Following the evaluation of the power cycle status by the processing logic, circuits and steps provide for the updating of the power cycle status for use in any future power cycle recovery processes.

Other features and advantages of the present invention will become appetent to those of skill in the art through a consideration of the ensuing description, the accompanying drawings, and the appended claims.

### DESCRIPTION OF THE SEVERAL VIEWS OF THE DRAWINGS

In the drawings, which illustrate what is currently considered to be the best mode for carrying out the invention:

FIG. 1 illustrates a block diagram of an electronic device incorporating the power cycling detector, in accordance with an embodiment of the present invention;

FIG. 2 illustrates a detailed block diagram of a short-power cycle detector, in accordance with an embodiment of the present invention;

FIG. 3 illustrates a detailed block diagram of a short-power cycle detector, in accordance with an alternate embodiment of the present invention;

FIG. 4 illustrates a timing diagram of the short-power cycle detector, in accordance with an embodiment of the present invention; and

FIG. 5 is a flow chart illustrating the method for detecting a short-power cycle, in accordance with an embodiment of the present invention.

### DETAILED DESCRIPTION OF THE INVENTION

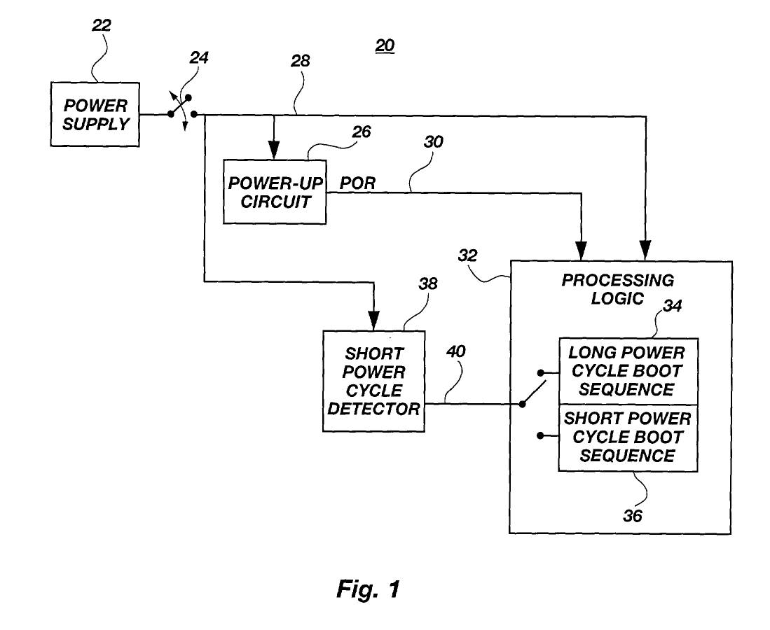

FIG. 1 illustrates a simplified block diagram of an electronic device 20, wherein the present invention may be practiced. It should be appreciated that electronic device 20 may take the form of a computerized device including computers, photocopiers, printers, and other electronic manufacturing and computer-controlled devices including embedded electronics. The present invention finds application in all such electronic devices wherein the power cycle boot sequence is of such a duration that the cycling of power is of concern and inconvenience to a user so as to make power cycling undesirable.

Electronic device 20 includes a source of power illustrated as power supply 22 which may be implemented, for example, as an AC-to-DC, DC-to-DC or other power supply configuration. Power supply 22 provides power to the operational component blocks of electronic device 20 and may be physically external to or internal with electronic device 20. Power supply 22 is illustrated as being connected with the other blocks and processes of electronic device 20 through a switch 24 illustrated as being capable of applying power to and removing power from the operational blocks, components and processes of electronic device 20. It should be appreciated that switch 24 may also be located on an opposing side of power supply 22, for regulating the application of power to power supply 22 which results in the same controlling effect upon the other operation blocks of electronic device 20.

It should also be appreciated that switch 24 is illustrated as being implemented as a manual switch for the power cycling (i.e., for the removal of power followed by the reapplication of power), of electronic device subsystems. While switch 24 is depicted as having a manual activation mechanism, it is also contemplated that such a device may be activated through electronic or other control means which detect a condition requiring power cycling in order to remove the then-present error condition.

Electronic device 20 is further comprised of a power-up circuit 26 which monitors power supply output 28 and provides a circuitry-hold or reset capability for activation while power supply output 28 stabilizes into a nontransient, steady-state level compatible for reliable use by the components of electronic device 20. During the stabilization of power supply output 28, power-up circuit 26 initiates a Power-On-Reset (POR) signal 30 utilized by other components of electronic device 20 for retaining their logic in a known reset state while power supply output 28 stabilizes, thereby allowing the processes of the other components of electronic device 20 to execute in a predictable manner as designed. Those of skill in the art appreciate the design and operational implementation of power-up circuit 26.

Electronic device 20 is further comprised of processing logic 32 which includes execution components and operational components for carrying out the operation design and performance of electronic device 20. By way of example, processing logic 32 may include functional blocks and processes which may be implanted by a microprocessor, microcontroller, or other execution device including associated peripherals such as memory and input-output components for carrying out the sequential operational aspects of electronic device 20. Processing logic 32 further comprises the executional logic utilized in the performance of the boot-up sequence of electronic device 20. Such boot-up sequences may include operations such as self-test, calibration and other performance-evaluating and performance-readying functionality.

As illustrated in FIG. 1, processing logic 32 includes an operational mechanism capable of selecting between various boot sequences, namely a long-power cycle boot sequence 34 and a short-power cycle boot sequence 36. While long-power cycle boot sequence 34 and short-power cycle boot sequence 36 are shown as being exclusive of each other, such a depiction is purely illustrative. Those of skill in the art appreciate that boot sequences are generally performed by executing a sequence of testing or evaluation procedures. Accordingly, short-power cycle boot sequence 36 will generally be implemented as a subset of long-power cycle boot sequence 34. That is to say, upon the detection of a short-power cycle, certain booting elements or tests within long-power cycle boot sequence 34 would not be executed and, therefore, would have a boot sequence illustrated as short-power cycle boot sequence 36 in FIG. 1.

In accordance with the present invention, in order to detect whether the power cycle has been one of an adequately short duration as to enable processing logic 32 to forego some portions of long-power cycle boot sequence 34, electronic device 20 is comprised of a short-power cycle detector 38. Detector 38 is coupled to power supply output 28 to monitor the fluctuations and durations associated with the power present on the processes and components of electronic device 20.

FIG. 1 further illustrates a status signal 40 which signifies the status of the power cycle, namely, whether the power cycle has been a short power cycle or a longer-duration power cycle. Status signal 40 is available for reading or access by processing logic 32 to facilitate the determination of the applicable boot sequence, namely, long-power cycle boot sequence 34 or short-power cycle boot sequence 36.

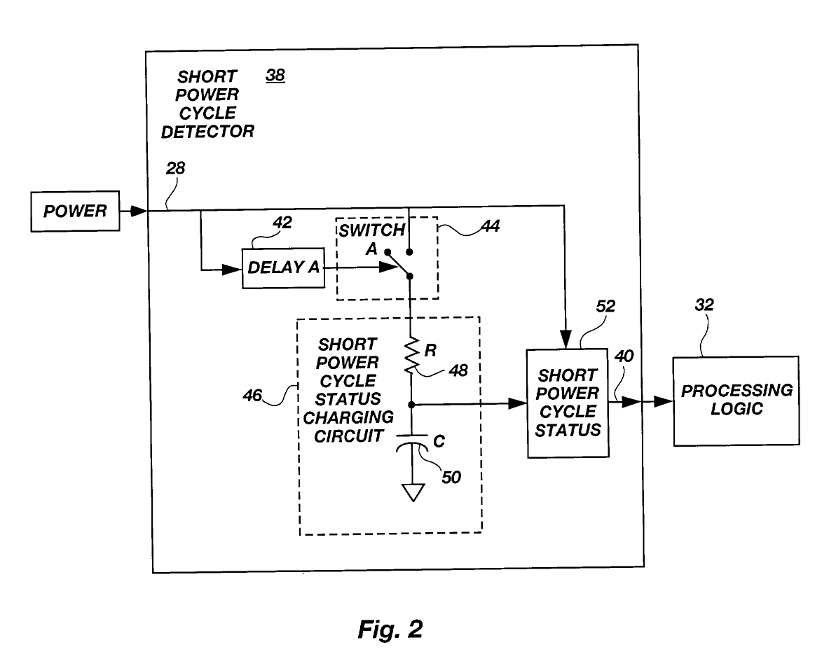

FIG. 2 illustrates a detailed block diagram of short-power cycle detector 38, in accordance with an embodiment of the present invention. Short-power cycle detector 38 operates by receiving power supply output 28 as a monitored input signal from which the power cycle duration is calculated. By way of an operational description, short-power cycle detector 38 receives power supply output 28 into a timing delay element 42 which controls a switch 44. Timing delay element 42 cooperatively interacts with switch 44 to provide electrical connection of power supply output 28 to a short-power cycle status charging circuit 46. The delay associated with timing delay element 42 in coupling power supply output 28 with charging circuit 46 enables the retention, over a short determinable duration, of a previously charged and stored status within charging circuit 46. That is to say, the delay associated with timing delay element 42 provides a reading grace period wherein processing logic 32 may determine the correct boot sequence in view of the power cycle prior to enabling switch 44 and allowing the power cycle status to be updated.

Those of skill in the art appreciate that charging circuit 46 is implemented, in the preferred embodiment, using a resistor 48 and a capacitor 50 arranged in an RC configuration. Those of skill in the art appreciate that such a resistor in an RC configuration provides flexibility in tailoring a waveform which provides a desirable time constant for data retention. Other configurations for providing a charging circuit 46 are also contemplated including other charge-storing or status-retaining mechanisms having memory capability.

Short-power cycle status charging circuit 46 is further operably coupled to a short-power cycle status block 52, which in one embodiment is implemented as a high-input impedance logic gate. Status block 52 makes available a status signal 40 for utilization by processing logic 32 in making a determination as to whether the power cycle has been of an adequately short duration so as to allow processing logic 32 to perform a subset of long-power cycle boot sequence 34, namely, short-power cycle boot sequence 36.

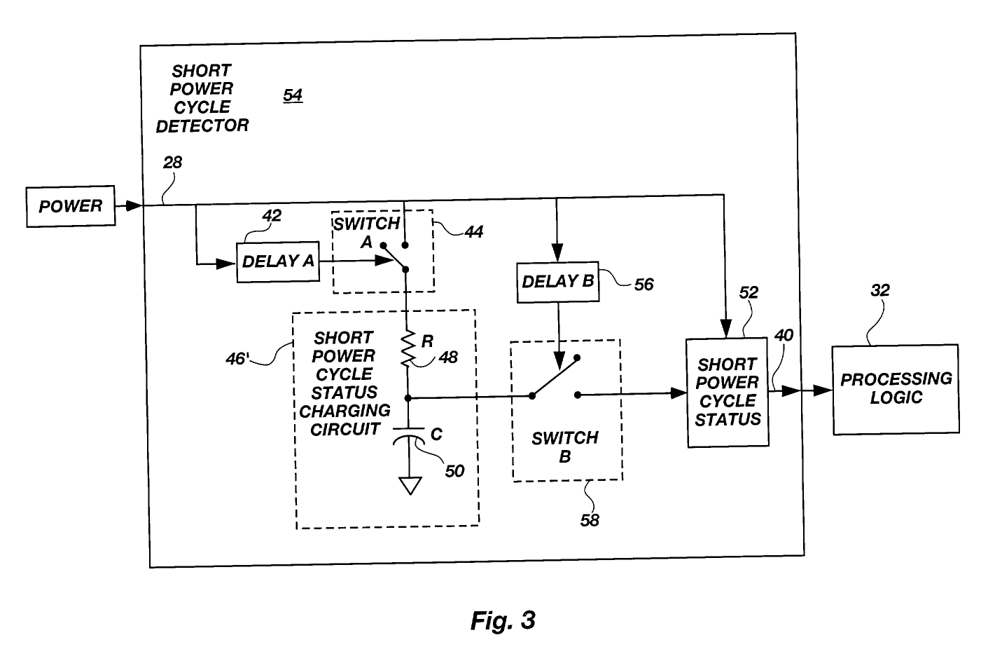

FIG. 3 illustrates an alternate embodiment of short-power cycle detector 54 in accordance with the present invention. Short-power cycle detector 54 integrates components similar to FIG. 2, namely, timing delay element 42 and switch 44 for regulating the power supplied to the charging circuit. Similar to the embodiment of FIG. 2, the charging circuit 46′ of FIG. 3 also includes an RC timing circuit for use in presenting a charge to status block 52. However, in detector 54, further isolation is obtained between the charge stored in status block 52 and any input circuitry through the utilization of a delay element 56 which is coupled to a switch 58. The utilization of further isolation of the status block minimizes any leakage of the storage status in status block 52 by the charging circuit 46′ when power is removed from power supply output 28. The inclusion of delay element 56 and switch 58 provides further isolation as well as an additional retiming of the connection of charging circuit 46′ to the status block 52. Delay element 56 may be configured as an analog delay or may be implemented as a digital timer which may be held in a reset state by the POR signal 30 (FIG. 1).

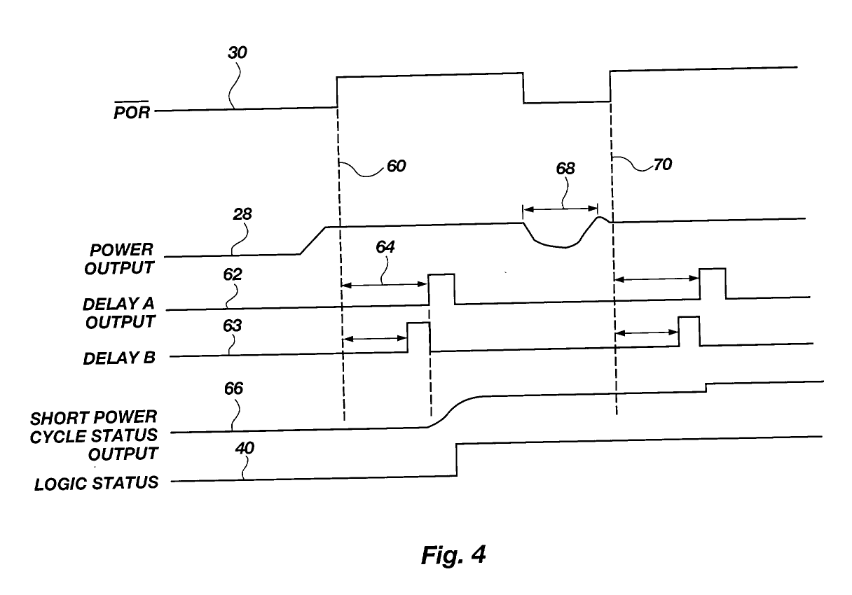

FIG. 4 illustrates a timing diagram of the various elements in accordance with the embodiments of the present invention. By way of example, FIG. 4 incorporates both embodiments of FIGS. 2 and 3 into the timing diagram by way of inclusion of the delay elements and switches 56 and 58, respectively. Upon initiation, power supply output 28 is applied within the electronic device and is illustrated as power supply output 28. It should be noted that upon the rising level of power supply output 28, POR 30 exhibits a delay until becoming active at time 60. POR 30 then remains unasserted during the sustained presence of power supply output 28. The output of timing delay element 42 (FIG. 3) illustrated as delay output 62 exhibits a delay duration 64 that is illustrated as being timed upon the release of POR 30 at time 60. It should be appreciated by those of skill in the art that the initiation of delay output 62 may also occur with respect to the rising power supply output 28. The assertion of delay output 62 at the end of delay duration 64, as should be recalled, facilitates the activation of switch 44 (FIGS. 2 and 3) for the charging of charging circuit 46. The timing signal associated with delay element 56 (FIG. 3) is illustrated as signal 63.

Charging circuit 46 charges, in the presence of power supply output 28, upon the closing of switch 44 in a profile as illustrated by short-power cycle status output 66. It should be noted that status output 66 degenerates over time and particularly during the short-power cycle phase illustrated as duration 68. Similarly, logic status output 40 is presented for reading by processing logic 32 (FIGS. 2 and 3) in a digital logical format.

Occurrence of a short-power cycle illustrated as duration 68, results in a second removal of POR 30 at a time 70 when processing logic 32 begins execution. During the execution process of processing logic 32, the logic associated therein reads logic status signal 40 and makes the determination that the most recent power cycle was of sufficiently short duration as to enable processing logic 32 to engage in a short-power cycle boot sequence 36 (FIG. 1), thus returning electronic device 20 into an operational state in a shorter duration than would otherwise occur without the retention of short-power cycle status output 66.

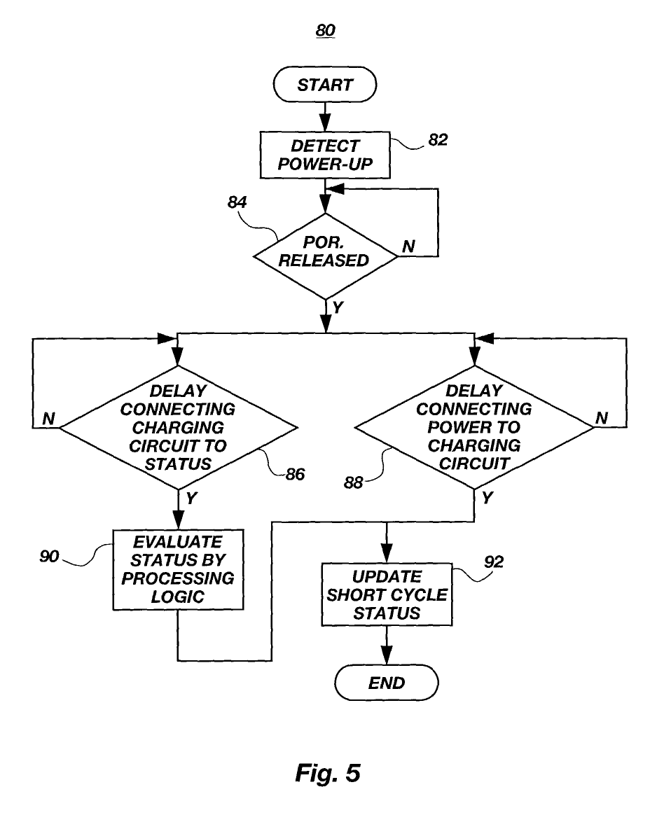

FIG. 5 is a flow chart illustrating a method for selecting a boot sequence corresponding to a power cycle duration, in accordance with an embodiment of the present invention. A method for selecting a boot sequence corresponding to a power cycle duration is represented generally as method 80. While specific steps are illustrated as occurring sequentially, it should be appreciated that steps may be exchanged in order and remain consistent with the scope of the present invention.

In method 80, a step 82 detects, in the electronic device, the transitions in the application of operation power from a first state where operational power is applied to the electronic device to a second state where operational power is removed from the electronic device and then to a third state where operational power is restored to the electronic device. Such a transition profile has been used herein as the term “power cycle.” Detection of a power cycle initiates isolation of status circuitry for status retention and consultation upon reapplication of operational power to the electronic device. Step 82 also activates power-up circuit 26 (FIG. 1) to assert POR 30 (FIG. 1) for retaining the processing logic and any other sensitive circuitry in a reset state pending stabilization of power supply output 28. While the detection of a power cycle may be used to isolate and preserve the status signal, the timing diagram of FIG. 4 illustrates the early latching of the status to avoid transients at the power-down phase of the power cycle.

Method 80 further includes a query step 84 for the determination of the release of POR 30 (FIG. 1) for enabling the power-cycle duration evaluation to proceed within the processing logic. A query step 86 delays connection of the charging circuit to the returned power output signal, thereby refraining from interfering with the stored power cycle status. In an another embodiment of the present invention, an additional delay may be implemented as query step 88 wherein the charging circuit is isolated from connecting the output of the charging circuit to the power cycle status block in order to allow additional prevention of interference within short-power cycle status block 52 (FIG. 3) until processing logic 32 (FIG. 3) completes the evaluation of the power cycle status.

A step 90 evaluates the power cycle status which includes an indication of a duration of the power cycle. When the evaluation determines that the power cycle was of a sufficiently short duration that some of the processes within the electronic device did not need to be reinitialized or verified and that execution with those processes within the electronic device could be performed without such re-initialization as occurred in an earlier boot-up sequence, the processing logic selects a shortened boot-up cycle, namely short-power cycle boot sequence 36 (FIG. 1) as the boot-up sequence signifying that processing may resume within the electronic device in a shortened amount of time due to the selection of an abbreviated boot-up sequence. Upon the stabilization of power supply output 28 (FIG. 1) and the evaluation of the power cycle status step 90, step 92 updates the power cycle status to indicate that the power cycle status is current in anticipation of any future power cycling that may occur.

A short-power cycle detector and method finding utility and application in a circuit for detecting a short-power cycle of an electronic device to enable a shortened boot sequence have been described and illustrated herein. The detector finds application in electronic devices including, but not limited to, computers, printers, copiers, and the like where the boot-up sequence is of sufficient duration as to be desirably shortened when possible. Although the present invention has been described with reference to specific embodiments, the invention is not limited to these embodiments. Rather, the invention is limited only by the appended claims, which include within their scope all equivalent devices or methods which operate according to the principles of the invention as described.

What is claimed is:

1. A short-power cycle detector, comprising:
a power cycle status block for retaining a power cycle status indicating a duration of a current power cycle following a completed boot sequence, said power cycle status block for interfacing with processing logic in an electronic device and allowing said processing logic to select a shortened boot sequence as a subsequent boot sequence when said duration of said current power cycle is less than a predetermined shortened duration wherein portions of said processing logic retain operational characteristics as initialized prior to said current power cycle; and
a charging circuit electrically coupled to said power cycle status block to update said power cycle status upon completion of said completed boot sequence.

2. The short-power cycle detector, as recited in claim 1, further comprising:
a first delay element electrically and operably coupled to said charging circuit to delay said current power cycle from updating said charging circuit, which in turn updates said power cycle status block before said processing logic evaluates said power cycle status during said subsequent boot sequence.

3. The short-power cycle detector, as recited in claim 2, further comprising:
a second delay element electrically and operably coupled between said charging circuit and said power cycle status block, said second delay element delaying said charging circuit from updating said power cycle status block while said power cycle status is evaluated by said processing logic during said subsequent boot sequence.

4. The short-power cycle detector, as recited in claim 3, wherein said second delay element is a digital delay element configured to isolate said charging circuit from said power cycle status block for a programmed delay while said power cycle status is evaluated by said processing logic during said subsequent boot sequence.

5. The short-power cycle detector, as recited in claim 4, wherein said programmed delay of said digital dealy element is controlled by a Power-On-Reset signal that retains said processing logic and said programmed delay in a reset state until power stabilizes following said current power cycle.

6. The short-power cycle detector, as recited in claim 1, wherein said charging circuit is implemented as an RC time constant circuit.

7. A circuit for detecting a short-power cycle of an electronic device to enable a shortened boot sequence, comprising:
a short-power cycle detector, including:
a power cycle status block for retaining a power cycle status indicating a duration of a current power cycle following a completed boot sequence; and
a charging circuit electrically coupled to said power cycle status block to update said power cycle status upon completion of said completed boot sequence to indicate the acceptability of said shortened boot sequence as a subsequent boot sequence if said current power cycle is of a predetermined shortened duration; and
processing logic operably coupled to said short-power cycle detector for evaluating said power cycle status, said power cycle status block for interfacing with said processing logic in said electronic device and allowing said processing logic to select a shortened boot sequence as said subsequent boot sequence when said duration of said current power cycle is less than said predetermined shortened duration wherein portions of said processing logic retain operational characteristics as initialized prior to said current power cycle.

8. The circuit, as recited in claim 7, wherein said short-power cycle detector further comprises:
a first delay element electrically and operably coupled to said charging circuit to delay said current power cycle from updating said charging circuit, which in turn updates said power cycle status block before said processing logic evaluates said power cycle status during said subsequent boot sequence.

9. The circuit, as recited in claim 8, wherein said short-power cycle detector further comprises:
a second delay element electrically and operably coupled between said charging circuit and said power cycle status block, said second delay element delaying said charging circuit from updating said power cycle status block while said power cycle status is evaluated by said processing logic during said subsequent boot sequence.

10. The circuit, as recited in claim 9, wherein said second delay element of said short-power cycle detector is a digital delay element configured to isolate said charging circuit from said power cycle status block for a programmed delay while said power cycle status is evaluated by said processing logic during said subsequent boot sequence.

11. The circuit, as recited in claim 10, wherein said programmed delay of said digital delay element is controlled by a Power-On-Reset signal that retains said processing logic and said programmed delay in a reset state until power stabilizes following said current power cycle.

12. The circuit, as recited in claim 7, wherein said charging circuit is implemented as an RC time constant circuit.

13. An electronic device, comprising: executable instructions for performing boot sequences including a long-power cycle boot sequence and a short-power cycle boot sequence; and
a circuit for detecting a short-power cycle of said electronic device to enable execution of said short-power cycle boot sequence, comprising:
a short-power cycle detector, including:
a power cycle status block for retaining a power cycle status indicating a duration of a current power cycle following a completed boot sequence; and
a charging circuit electrically coupled to said power cycle status block to update said power cycle status upon completion of said completed boot sequence to indicate the acceptability of said short-power boot sequence as a subsequent boot sequence if said current power cycle is of a predetermined shortened duration; and
processing logic operably coupled to said short-power cycle detector for evaluating said power cycle status, said power cycle status block for interfacing with said processing logic in said electronic device and allowing said processing logic to perform said short-power cycle boot sequence as said subsequent boot sequence when said duration of said current power cycle is less than said predetermined shortened duration wherein portions of said processing logic retain operational characteristics as initialized prior to said current power cycle.

14. The electronic device, as recited in claim 13, wherein said short-power cycle detector further comprises:
a first delay element electrically and operably coupled to said charging circuit to delay said current power cycle from updating said charging circuit, which in turn updates said power cycle status block before said processing logic evaluates said power cycle status during said subsequent boot sequence.

15. The electronic device, as recited in claim 14, wherein said short-power cycle detector further comprises:
a second delay element electrically and operably coupled between said charging circuit and said power cycle status block, said second delay element delaying said charging circuit from updating said power cycle status block while said power cycle status is evaluated by said processing logic during said subsequent boot sequence.

16. The electronic device, as recited in claim 15, wherein said second delay element of said short-power cycle detector is a digital delay element configured to isolate said charging circuit from said power cycle status block for a programmed delay while said power cycle status is evaluated by said processing logic during said subsequent boot sequence.

17. The electronic device, as recited in claim 16, wherein said programmed delay of said digital delay element is controlled by a Power-On-Reset signal that retains said processing logic and said programmed delay in a reset state until power stabilizes following said current power cycle.

18. The electronic device, as recited in claim 13, wherein said charging circuit is implemented as an RC time constant circuit.

19. In an electronic device, a method for selecting a boot sequence corresponding to a power cycle duration, said method comprising the:
detecting a current power cycle of said electronic device;
temporarily isolating a charging circuit from updating a power cycle status stored in a temporarily nonvolatile power cycle status block of said electronic device;
upon return of power to said electronic device, evaluating said power cycle status which includes an indication of a duration of said current power cycle;
selecting a short-power cycle boot sequence when said power cycle status is less than a predetermined shortened duration; and
updating said power cycle status of said electronic device by said charging circuit.

20. The method as recited in claim 19, wherein said temporarily isolating comprises:
upon return of power to said electronic device, opening a first switch between said charging circuit and said power to said electronic device; and
delaying closing of said first switch until said evaluating step completes.

21. The method as recited in claim 20, wherein said temporarily isolating comprises:
upon stabilization of said power to said electronic device, opening a second switch between said charging circuit and said power cycle status block; and
delaying closing of said second switch until said evaluating step completes.
